(19) United States
(12) Patent Application Publication
(10) Pub. No.: US 2025/0054001 A1
(43) Pub. Date: Feb. 13, 2025

(54) SYSTEM AND METHOD FOR FORECAST ADJUSTMENT

(71) Applicant: Kinaxis Inc., Ottawa (CA)

(72) Inventors: Ali KHANAFER, Ottawa (CA); Behrouz HAJI SOLEIMANI, Ottawa (CA)

(21) Appl. No.: 18/800,753

(22) Filed: Aug. 12, 2024

Related U.S. Application Data
(60) Provisional application No. 63/518,713, filed on Aug. 10, 2023.

(51) Int. Cl. G06Q 30/0201; G06N 20/00

(52) U.S. Cl. CPC G06Q 30/0201; G06N 20/00

(57) ABSTRACT

Disclosed are systems and methods that relate to demand forecasting based on machine learning of historical data, while adjusting forecasts based real-time data.

The present application claims the benefit of U.S. Provisional Patent Application No. 63/518,713 filed Aug. 10, 2023, which is entirely herein by reference.

### BACKGROUND

Demand sensing uses artificial intelligence and machine learning algorithms to capture short-term and long-term demand patterns. Demand sensing is a valuable technique in the marketplace for forecasting. However, once a demand-sensing machine learning pipeline is in production, changes to the pipeline are difficult and costly to implement. There is a need to incorporate timely information into machine learning pipeline in a manner that utilizes computer resources in an efficient manner, without the need to implement costly, resource-intensive changes.

### BRIEF SUMMARY

In one aspect, a computing apparatus is provided, that includes a processor. The computing apparatus also includes a memory storing instructions that, when executed by the processor, configure the apparatus to: receive, by the processor, historical data includes data compiled over a first time interval; clean, by the processor, the historical data in preparation for feature generation; generate, by the processor, a plurality of features based on the historical data; train, by the processor, a machine-learning model using the plurality of features; generate, by the processor; forecast data for a forecast window; collect, by the processor, real-time data over a second time interval, the second time interval less than the forecast window; determine, by the processor, an error in the forecast data, based on a difference between the forecast data and the real-time data; and form, by the processor, an adjusted forecast data by removing the error from the forecast data.

In the computing apparatus, the machine learn model can be a deep-learning model, a statistical model, or a tree-based model. Where the machine learning model is a tree-based model, the instructions can further configure the apparatus to: join, by the processor, clean data obtained from a plurality of sources, into a single source; and tune, by the processor, one or more hyperparameters.

In the computing apparatus, the historical data may comprise historical sales data at a plurality of store locations, the real-time data may comprise daily sales data at each store location of the plurality of store locations; when determining the error, the apparatus can be configured to: compare, by the processor, on a daily basis during the second time interval, the difference between the forecast data and the daily sales data at each store location; and determine, by the processor, an average error across the plurality of store locations; and when forming the adjusted forecast data, the computing apparatus can be configured to remove, by the processor, the average error from the forecast data at each store location.

In the computing apparatus, the instructions can further configure the apparatus to: combine, by the processor, the real-time data with the historical data; clean, by the processor, the historical data and the real-time data; generate, by the processor, a second plurality of features based on the historical data and the real-time data; re-train, by the processor, the machine-learning model using the second plurality of features; generate, by the processor, a second set of forecast data for the forecast window; collect, by the processor, a second set of real-time data over the second time interval; determine, by the processor, a second error in the second set of forecast data, based on a second difference between the second set of forecast data and the second set of real-time data; and form, by the processor, a second adjusted forecast data.

In the computing apparatus, the historical data can comprise sales data, and at least one of weather data, financial data and seasonal data. Other technical features may be readily apparent to one skilled in the art from the following figures, descriptions, and claims.

In one aspect, a non-transitory computer-readable storage medium is provided, the computer-readable storage medium including instructions that when executed by a computer, cause the computer to: receive, by a processor, historical data includes data compiled over a first time interval; clean, by the processor, the historical data in preparation for feature generation; generate, by the processor, a plurality of features based on the historical data; train, by the processor, a machine-learning model using the plurality of features; generate, by the processor, forecast data for a forecast window; collect, by the processor, real-time data over a second time interval, the second time interval less than the forecast window; determine, by the processor, an error in the forecast data, based on a difference between the forecast data and the real-time data; and form, by the processor, an adjusted forecast data by removing the error from the forecast data.

In the non-transitory computer-readable storage medium, the machine learn model can be a deep-learning model, a statistical model, or a tree-based model. Where the machine learning model is a tree-based model, the instructions can further configure the computer to: join, by the processor, clean data obtained from a plurality of sources, into a single source; and tune, by the processor, one or more hyperparameters.

In the non-transitory computer-readable storage medium, the historical data may comprise historical sales data at a plurality of store locations, the real-time data may comprise daily sales data at each store location of the plurality of store locations; when determining the error, the computer can be configured to: compare, by the processor, on a daily basis during the second time interval, the difference between the forecast data and the daily sales data at each store location, and determine, by the processor, an average error across the plurality of store locations; and when forming the adjusted forecast data, the computer can be configured to remove, by the processor, the average error from the forecast data at each store location.

In the non-transitory computer-readable storage medium, the instructions can further configure the computer to: combine, by the processor, the real-time data with the historical data; clean, by the processor, the historical data and the real-time data; generate, by the processor, a second plurality of features based on the historical data and the real-time data; re-train, by the processor, the machine-learning model using the second plurality of features; generate, by the processor, a second set of forecast data for the forecast window; collect, by the processor, a second set of real-time data over the second time interval; determine, by the processor, a second error in the second set of forecast data, based on a second difference between the second set of forecast data and the second set of real-time data; and form, by the processor, a second adjusted forecast data.

In the non-transitory computer-readable storage medium, the historical data can comprise sales data, and at least one of weather data, financial data and seasonal data. Other technical features may be readily apparent to one skilled in the art from the following figures, descriptions, and claims.

In one aspect, a computer-implemented method is provided, that comprises: receiving, by a processor, historical data includes data compiled over a first time interval; cleaning, by the processor, the historical data in preparation for feature generation; generating, by the processor, a plurality of features based on the historical data; training, by the processor, a machine-learning model using the plurality of features; generating, by the processor, forecast data for a forecast window; collecting, by the processor, real-time data over a second time interval, the second time interval less than the forecast window; determining, by the processor, an error in the forecast data, based on a difference between the forecast data and the real-time data; and forming, by the processor, an adjusted forecast data by removing the error from the forecast data.

In the computer-implemented method, the machine learning model can be a deep-learning model, a statistical model, or a tree-based model. Where the machine learning model is a tree-based model, the method can further comprise: joining, by the processor, clean data obtained from a plurality of sources, into a single source; and tuning, by the processor, one or more hyperparameters.

In the computer-implemented method, the historical data can include historical sales data at a plurality of store locations, the real-time data can include daily sales data at each store location of the plurality of store locations; where determining the error includes: comparing, by the processor, on a daily basis during the second time interval, the difference between the forecast data and the daily sales data at each store location; and determining, by the processor, an average error across the plurality of store locations; and where forming the adjusted forecast data includes removing, by the processor, the average error from the forecast data at each store location.

The method may further include: combining, by the processor, the real-time data with the historical data; cleaning, by the processor, the historical data and the real-time data, generating, by the processor, a second plurality of features based on the historical data and the real-time data; re-training, by the processor, the machine-learning model using the second plurality of features; generating, by the processor, a second set of forecast data for the forecast window; collecting, by the processor, a second set of real-time data over the second time interval; determining, by the processor, a second error in the second set of forecast data, based on a second difference between the second set of forecast data and the second set of real-time data; and forming, by the processor, a second adjusted forecast data.

In the computer-implemented method, the historical data can include sales data, and at least one of weather data, financial data and seasonal data. Other technical features may be readily apparent to one skilled in the art from the following figures, descriptions, and claims.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a simple block diagram of a system in accordance with an embodiment.

FIG. 2 illustrates a block diagram of a method for forecasting using a machine learning technique in accordance with an embodiment.

FIG. 3 illustrates a block diagram for training a tree-based machine learning model in accordance with one embodiment.

FIG. 4 illustrates a block diagram for training a tree-based machine learning model in accordance with one embodiment.

FIG. 5 illustrates a block diagram for adjusting a forecast provided by a forecast model in accordance with an embodiment.

FIG. 6 illustrates exemplary values of forecast data and adjusted forecast data in accordance with an embodiment.

FIG. 7 illustrates a graphical representation of forecast data and adjusted forecast data in accordance with an embodiment.

### DETAILED DESCRIPTION

Aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable storage media having computer readable program code embodied thereon.

Many of the functional units described in this specification may be labeled as modules, in order to emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more computer readable storage media.

Any combination of one or more computer readable storage media may be utilized. A computer readable storage medium may be, for example, but not limited to, an electronic, magnetic, optical, electromagnetic, infrared, or semiconductor system, apparatus, or device, or any suitable combination of the foregoing.

More specific examples (a non-exhaustive list) of the computer readable storage medium can include the following: a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), a Blu-ray disc, an optical storage device, a magnetic tape, a Bernoulli drive, a magnetic disk, a magnetic storage device, a punch card, integrated circuits, other digital processing apparatus memory devices, or any suitable combination of the foregoing, but would not include propagating signals. In the context of this document, a computer readable storage medium may be any tangible medium that can contain, or store a program for use by or in connection with an instruction execution system, apparatus, or device.

Computer program code for carrying out operations for aspects of the present disclosure may be written in any combination of one or more programming languages, including an object oriented programming language such as Java, Python, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the disclosure may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the disclosure. However, the disclosure may be practiced without one or more of the specific details, or with other methods, components, materials, and so forth. In other instances, well-known structures, materials, or operations are not shown or described in detail to avoid obscuring aspects of the disclosure.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor(s) of a general purpose computer(s), special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

These computer program instructions may also be stored in a computer readable storage medium that can direct a computer, other programmable data processing apparatus, or other devices to function in a particular manner, such that the instructions stored in the computer readable storage medium produce an article of manufacture including instructions which implement the function/act specified in the schematic flowchart diagrams and/or schematic block diagrams block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present disclosure. In this regard, each block in the schematic flowchart diagrams and/or schematic block diagrams may represent a module, segment, or portion of code, which comprises one or more executable instructions for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer instructions.

The description of elements in each figure may refer to elements of proceeding figures. Like numbers refer to like elements in all figures, including alternate embodiments of like elements.

A computer program (which may also be referred to or described as a software application, code, a program, a script, software, a module or a software module) can be written in any form of programming language. This includes compiled or interpreted languages, or declarative or procedural languages. A computer program can be deployed in many forms, including as a module, a subroutine, a stand-alone program, a component, or other unit suitable for use in a computing environment. A computer program can be deployed to be executed on one computer or can be deployed on multiple computers that are located at one site or distributed across multiple sites and interconnected by a communication network.

As used herein, a “software engine” or an “engine,” refers to a software implemented system that provides an output that is different from the input. An engine can be an encoded block of functionality, such as a platform, a library, an object or a software development kit (“SDK”). Each engine can be implemented on any type of computing device that includes one or more processors and computer readable media. Furthermore, two or more of the engines may be implemented on the same computing device, or on different computing devices. Non-limiting examples of a computing device include tablet computers, servers, laptop or desktop computers, music players, mobile phones, e-book readers, notebook computers, PDAs, smart phones, or other stationary or portable devices.

The processes and logic flows described herein can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit). For example, the processes and logic flows that can be performed by an apparatus, can also be implemented as a graphics processing unit (GPU).

Computers suitable for the execution of a computer program include, by way of example, general or special purpose microprocessors or both, or any other kind of central processing unit. Generally, a central processing unit receives instructions and data from a read-only memory or a random access memory or both. A computer can also include, or be operatively coupled to receive data from, or transfer data to, or both, one or more mass storage devices for storing data, e.g., optical disks, magnetic, or magneto optical disks. It should be noted that a computer does not require these devices. Furthermore, a computer can be embedded in another device. Non-limiting examples of the latter include a game console, a mobile telephone a mobile audio player, a personal digital assistant (PDA), a video player, a Global Positioning System (GPS) receiver, or a portable storage device. A non-limiting example of a storage device include a universal serial bus (USB) flash drive.

Computer readable media suitable for storing computer program instructions and data include all forms of non-volatile memory, media and memory devices; non-limiting examples include magneto optical disks; semiconductor memory devices (e.g., EPROM, EEPROM, and flash memory devices); CD ROM disks; magnetic disks (e.g., internal hard disks or removable disks); and DVD-ROM disks. The processor and the memory can be supplemented by, or incorporated in, special purpose logic circuitry.

To provide for interaction with a user, embodiments of the subject matter described herein can be implemented on a computer having a display device for displaying information to the user and input devices by which the user can provide input to the computer (for example, a keyboard, a pointing device such as a mouse or a trackball, etc.). Other kinds of devices can be used to provide for interaction with a user. Feedback provided to the user can include sensory feedback (e.g., visual feedback, auditory feedback, or tactile feedback). Input from the user can be received in any form, including acoustic, speech, or tactile input. Furthermore, there can be interaction between a user and a computer by way of exchange of documents between the computer and a device used by the user. As an example, a computer can send web pages to a web browser on a user's client device in response to requests received from the web browser.

Embodiments of the subject matter described in this specification may be implemented in a computing system that includes: a front end component (e.g., a client computer having a graphical user interface or a Web browser through which a user can interact with an implementation of the subject matter described herein); or a middleware component (e.g., an application server); or a back end component (e.g. a data server); or any combination of one or more such back end, middleware, or front end components. The components of the system can be interconnected by any form or medium of digital data communication, e.g., a communication network. Non-limiting examples of communication networks include a local area network (“LAN”) and a wide area network (“WAN”).

The computing system can include clients and servers. A client and server are generally remote from each other and typically interact through a communication network. The relationship of client and server arises by virtue of computer programs running on the respective computers and having a client-server relationship to each other.

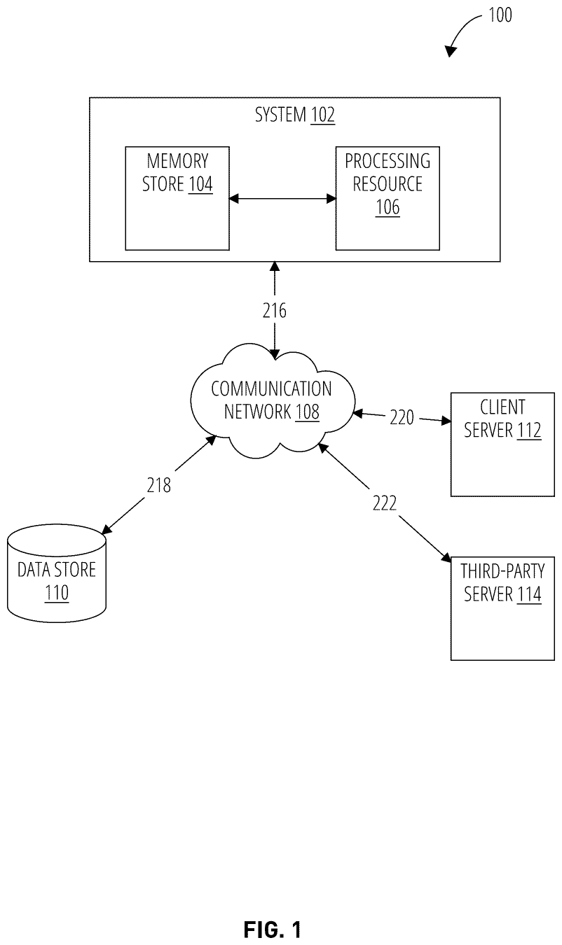

In FIG. 1, system 102 is shown in an exemplary Environment 100 with which some embodiments may operate. System 102 includes a memory store 104 and a processing resource 106. Processing resource 106 may include one or more processors and/or controllers, which may take the form of a general or a special purpose processor(s) or controller(s). In exemplary implementations, processing resource 106 may be, or include, microprocessors, microcontrollers, application specific integrated circuits, digital signal processors, and/or other data processing devices. Processing resource 106 may be a single device or distributed over a network.

Memory store 104 may be, or include, one or more non-transitory computer-readable storage media, such as optical, magnetic, organic, or flash memory, among other data storage devices and may take any form of computer readable storage media. Remote data store 110 may be a single device or may be distributed over a network.

Processing resource 106 and memory store 104 may be communicatively coupled by a system communication bus, a wired network, a wireless network, or other connection mechanism and arranged to carry out various operations described herein. Optionally, two or more of these components may be integrated together in whole or in part.

System 102 is communicatively coupled to a communication network 108 as shown by arrow 116. Communication network 108 may include one or more computing systems and may be any suitable combination of networks or portions thereof to facilitate communication between network components. Some examples of networks include, Wide Area Networks (WANs), Local Area Networks (LANs), Wireless Wide Area Networks (WWANs), data networks, cellular networks, voice networks, among other networks, which may be wired and/or wireless. Communication network 108 may operate according to one or more communication protocols, such as, General Packet Radio Service (GPRS), Universal Mobile Telecommunications Service (UMTS), Global System for Mobile (GSM), Enhanced Data Rates for GSM Evolution (EDGE), Long Term Evolution (LTE), CDMA (Code-division Multiple Access) (CDMA), WCDMA (Wide Code-division Multiple Access), (High Speed Packet Access (HSPA), Evolved HSPA (HSPA+), Low-power WAN (LPWAN), Wi-Fi, Bluetooth, Ethernet, Hypertext Transfer Protocol Secure (HTTP/S), Transmission Control Protocol/Internet Protocol (TCP/IP), and Constrained Application Protocol/Datagram Transport Layer Security (CoAP/DTLS), or other suitable protocol. Communication network 108 may take other forms as well.

Also shown in FIG. 1 is a remote data store 110, remote client server 112 and remote third-party server 114, each communicatively coupled to communication network 108, as shown by arrows 118, 120 and 122, respectively. For example, system 102 can communicate with data store 110, client server 112 and third-party server 114, via communication network 108. Furthermore, data store 110 can communicate with client server 112 and third-party server 114, via communication network 108.

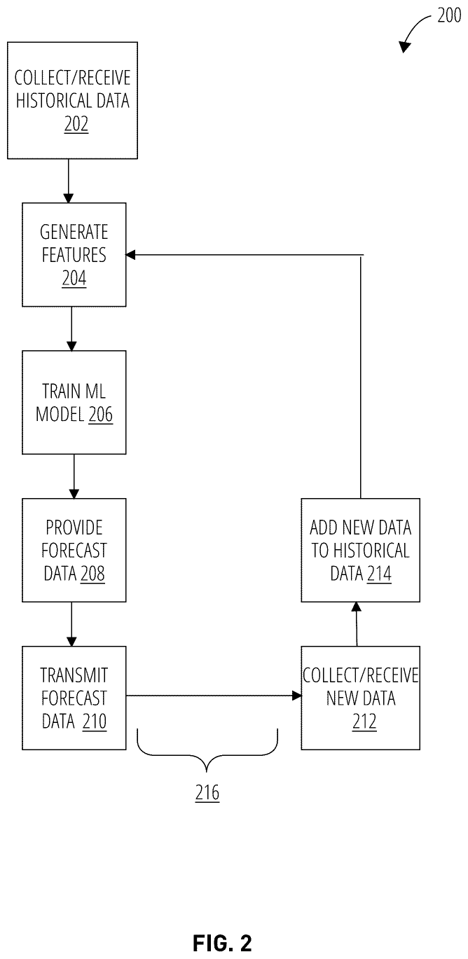

Demand sensing is commonly relied upon by retailers and manufacturers to ensure adequate supply of a product is in their stores, and that inventory is present in order to meet customer demand. A simple block diagram 200 for forecasting demand, using a machine learning technique according to an embodiment is shown in FIG. 2.

The exemplary method illustrated in block diagram 200 can be carried out by system 102 shown in FIG. 1. Alternatively, the exemplary method may be carried out by another system, a combination of other systems, subsystems, devices or other suitable means provided the operations described herein are performed. The exemplary method may be automated, semi-automated and some blocks thereof may be manually performed.

In a first example, a retailer owns a number of stores located at various locations. The retailer, also referred to herein as a user, wishes to receive a forecast for the daily demand of a first product for each of the store locations, for a fixed period of time (the fixed period of time is also referred to as a “forecast window”). The forecast window allows for both short-term and long-term planning. Alternatively, and/or optionally, the forecast may be for a different product, a unique store(s), and so on. As an example, a user requests forecast data indicating the daily demand for the first product in each of 150 stores, over a 4-week period. In this example, the forecast window is 4 weeks.

At block 202, historical data can be collected during a first time interval. For example, the retailer can transmit, from client server 112 to data store 110, sales data of the first product, on a daily basis, corresponding to each store location. The sales data can be collected and stored daily in data store 110 over the first time interval for future use. Continuing from the example above of 150 stores, the first time interval can be 1 year. In practice, sales data may be collected over any time interval, e.g., weeks, months, years, etc.

In a further example, weather data corresponding to the first time interval can also be collected. The weather data can be hourly, daily, and so forth. For instance, daily weather data from third-party server 114, such as a server storing weather conditions, can be obtained by processing resource 106 and stored in data store 110 for future use. Sales data transmitted by the user, along with the weather data obtained by processing resource 106, for a period over the first time interval, is referred to as historical data. In addition, or alternatively, other third party signals can include: the time of year, local holidays, events, market indexes at each respective location, amongst other signals.

Next, at block 204, feature data can be generated, indicative of features used for training a machine learning model. For example, processing resource 106 may massage, process and/or transform historical data (collected at block 202) in order to generate feature data used to train a machine learning model for creating a forecast model. The term “cleaning” comprises at least one of massaging, processing and transforming historical data.

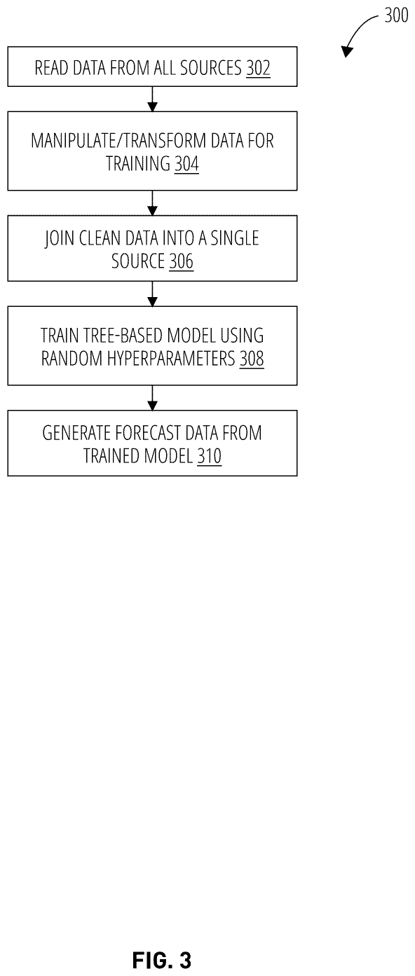

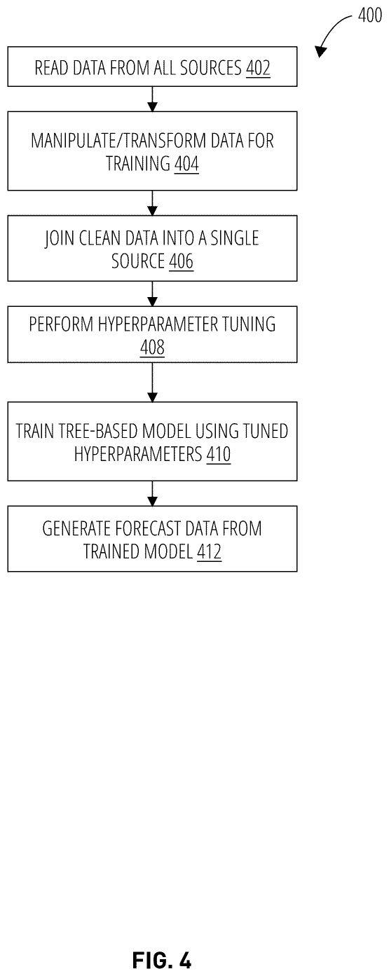

Next, at block 206, a machine learning model can be trained, using the feature data generated at block 204. For example, processing resource 106, can train a machine learning model, using the generated feature data, for forming a forecast model. The machine learning model can be a deep learning model that incorporate Recurrent Neural Networks, Convolution Neural Networks, or Transformer Models. Alternatively, the machine learning model can be a statistical model, such as SARIMAX or a procedure for forecasting time series data based on an additive model where non-linear trends are fit with seasonality, plus holiday effects. The machine learning model can also be a tree-based model. Training of a tree-based learning model is described further in FIG. 3 and FIG. 4.

Next, at block 208, forecast data can then be generated by the trained machine learning model. For example, using the forecasting model formed at block 206, processing resource 106 can generate forecast data indicating the daily demand for the first product for each of the user's stores, over the forecast window. In the example cited above, this entails forecasting daily demand at each of the user's 150 stores across a forecast window of 4 weeks (or 28 days).

Next, at block 210, the forecast data (generated at block 208) can be transmitted to the user. For example, processing resource 106 can transmit the forecast data to client server 112 via communication network 108.

Next, at block 212, new data can be collected over a second period of time. New data refers to data corresponding to the type of data that was collected during the first time interval, but is now collected over the second time period. In practice, the second time interval can be shorter than the forecast window.

For example, the user may transmit actual sales data of the first product for each store on a daily basis. This transmission can take place from client server 112 to data store 110. The daily sales data can be collected over the second time interval, for example, 1 week, and stored in data store 110 for future use. In practice, sales data may be collected over any time interval, e.g., days, weeks, months, years, etc. In practice, the second time interval can be shorter than the forecast window.

If weather data has been collected as part of the historical data, then weather data corresponding to the second time interval can also be also collected. In fact, any other signal that were collected as part of the historical data, can also be collected during the second time interval, such that all the data collected during the second time period, is referred to as “new data’.

For instance, daily weather data from third-party server 114, such as a server storing weather conditions, can be fetched by processing resource 106 and stored in data store 110 for future use. This can also apply to other third-party signals Sales data transmitted by the user, along with any weather data and/or other third-party data fetched by processing resource 106 over the second time interval, is referred to as new data.

This can include daily weather data. In the example cited above, where the second time interval is 1 week, new data can include daily sales data, along with weather data and other third-party signals corresponding to each day of that 1 week period.

At block 214, the new data can be added to the historical data. For example, the new data can be added to the historical data stored in data store 110.

Finally, the exemplary method can return to block 204 wherein features are generated. Features can be based on the new data, and can be used for re-training the machine learning model at block 206 for forming another forecast model. Alternatively, the features of the new data can be used to train a new machine learning model at block 206.

In practice, the exemplary method may be a portion of a machine learning pipeline. In such cases, the size of historical data and/new data may be large, e.g., terabytes, petabytes, etc., causing implementation of the exemplary method in a machine learning pipeline to be expensive in terms of time, cost and resources. In the example provided above, although sales data is collected on a daily basis, feature generation, training a machine learning model, and providing a forecast occurs once every 7 days. In some instances, however, a retailer/user may request to receive an updated forecast on a more frequent basis based on the most recent sales data available. To accommodate the user's request, the machine learning pipeline would need to be run more frequently (for example, on a daily basis), which is expensive as described above, and/or, the pipeline may need re-structuring, which may not be feasible. Described below are methods and system that allow for incorporating real-time data to adjust the forecast, without executing the resource-intensive machine-learning model on a daily basis.

FIG. 3 illustrates a block diagram for training a tree-based machine learning model in accordance with one embodiment.

In an embodiment where a tree-based machine learning model is used, at training process can proceed as follows. Historical data can be read from separate tables in a data warehouse, as shown at block 302. This is followed by data manipulations and transformations that are performed to prepare the model for training (block 304). Clean data can be joined together into a single data source comprising the quantity sold of a single product, at a single store on any given day, plus any additional features (for example product features, store features, promotion features, etc.), at block 306. At this point, the model can be trained using random hyperparameters, at block 308. Finally, a forecast can be produced from the trained tree-based model at block 310).

FIG. 4 illustrates a block diagram for training a tree-based machine learning model in accordance with one embodiment.

In an embodiment where a tree-based machine learning model is used, at training process can proceed as follows. Historical data can be read from separate tables in a data warehouse, as shown in block 402. This is followed by data manipulations and transformations that are performed to prepare the model for training (block 404). Clean data can be joined together into a single data source comprising the quantity sold of a single product, at a single store on any given day, plus any additional features (for example product features, store features, promotion features, etc.), in block 406. At this point, rather than training the machine learning model using random hyperparameters (as is illustrated in FIG. 3), hyper-parameters of the forecast model may be tuned to improve accuracy of the model, at block 408. That is, after generating the dataset, hyperparameter tuning can be performed using the dataset, in order to obtain optimal tree-based model parameters. The tree-based model can then be trained using the optimal hyperparameters, at block 410. A forecast can then be produced from the trained tree-based model, where hyperparameter tuning was performed. Finally, a forecast can then be generated from the trained tree-based model at block 412.

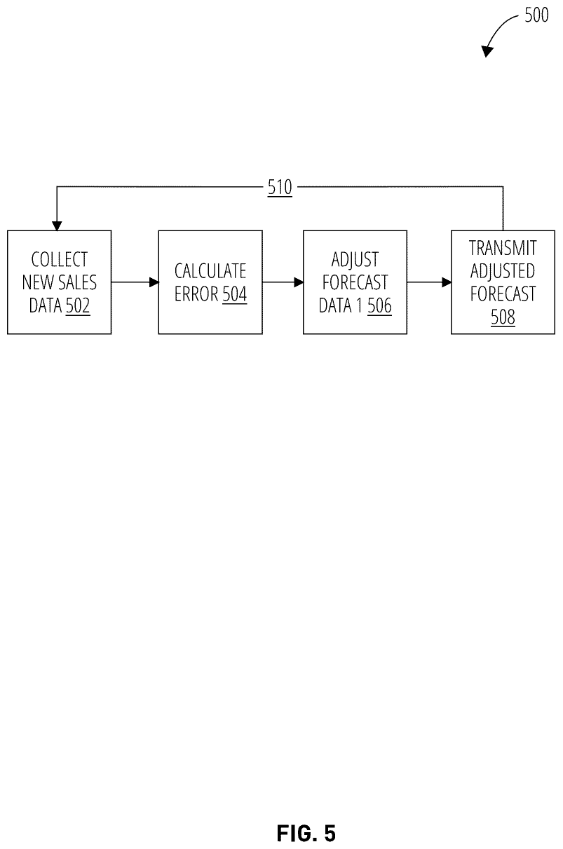

FIG. 5 illustrates an embodiment of a method that updates a forecast based on the most recent sales data available, without executing the machine learning pipeline more frequently (which is resource intensive) or without re-structuring the pipeline (which may not be feasible).

FIG. 5 illustrates a block diagram 500 for adjusting a forecast provided by a forecast model in accordance with an embodiment. Block diagram 500 provides a method for adjusting forecast data provided by a machine learning model, based on new sales data and the forecast data. The method for adjusting forecast data can be carried out by system 102. Block diagram 500 includes blocks 502, 504, 506, and 508, sequentially, and is included in the method illustrated in FIG. 2, located between block 210 and block 212, as indicated by bracket 216.

The user wishes to receive a daily forecast for each first product corresponding to each of the user's store locations.

Continuing with the same example as described herein above, the user wishes to receive a daily forecast for each first product corresponding to each of the 150 store locations.

At block 502, new sales data can be collected during the second time interval. For example, the user transmits sales data for Day 1 of the 28 day (4-week) forecast window. The sales data includes sales data of the first product corresponding to each store. The sales data can be transmitted from Client server 112 to Data store 110 and stored in Data store 110 for future use.

Next, at block 504, Block diagram 500 includes determining an error based on forecast data provided at block 208 and new sales (that is, actual sales) data collected during the second time interval. For example, processing resource 106 may determine an error in the form of an average percentage of error across all stores for the first product between the forecast data and the new sales (that is, actual sales) data for Day 1.

For instance, for a first store of the 150 stores, processing resource 106 determines the percentage error between the forecasted demand of the first product corresponding to that store on Day 1 and the new sales (that is, actual sales) data collected on Day 1. Forecast data for Day 1 indicates product demand for the first product corresponding to the first store to be 10 units. The new sales (that is, actual sales) data collected for the first product and corresponding to the first store indicates 9 units were actually sold. Processing resource 106 determines there is a percentage error of [(9-10)/10]*100=−10% error between the forecast data and the new sales (i.e, actual sales) data for the first store location during the second time interval.

Next, for each of the remaining 149 store locations, processing resource 106 determines the percentage error between the forecasted demand of the first product and the new sales (i.e., actual sales) data for Day 1 in a similar manner as described above.

Then processing resource 106 may then average the percentage error of all stores. For example, processing resource 106 determines the average percentage error across all stores is-2%.

Next at block 506, Block diagram 500 includes removing the error from the forecast data for forming adjusted forecast data. For example, processing resource 106 removes the average percentage error across all stores, −2%, from the forecast data for each of the 28 day forecast window, for forming adjusted forecast data.

Finally, at block 508, Block diagram 500 includes transmitting the adjusted forecast data. For example, processing resource 106 transmits the adjusted forecast data to Client server 112 via Communication network 108.

Optionally, Block diagram 500 returns to block 502 as indicated by arrow 510. At block 502, Block diagram 500 includes collecting new sales data during a third time interval. For example, the user transmits sales data for Day 2 of the 28 day (4-week) forecast window. The sales data includes sales data of the first product corresponding to each store on Day 2. The sales data is transmitted from Client server 112 to Data store 110 and stored in Data store 110 for future use.

Next, at block 504, Block diagram 500 includes determining an error based on forecast data provided at block 208 and new sales (i.e., actual sales) data collected during the third time interval. For example, processing resource 106 determines an error in the form of an average percentage of error across all stores for the first product between the forecast data and the new sales (i.e, actual sales) data for Day 2. For example, processing resource 106 determines the average percentage error across all stores in a similar manner as described above to be about-6%

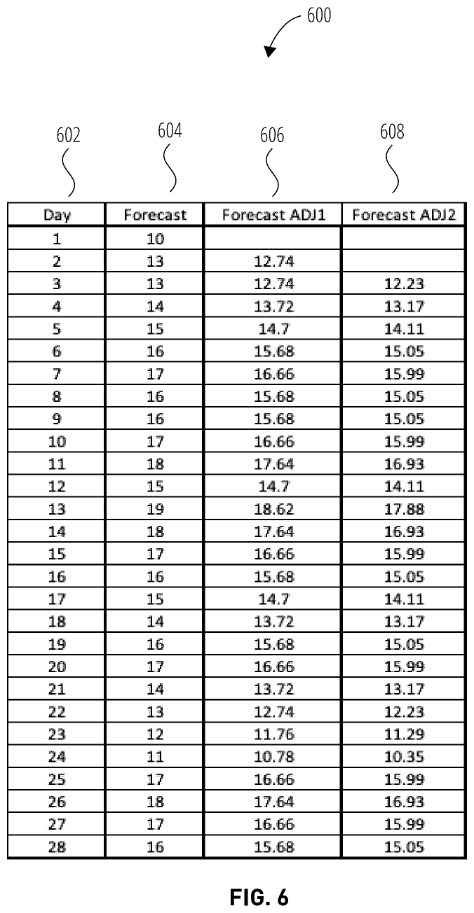

Referring now to FIG. 6, shown in table 600 is exemplary forecast data in column 604 for the first product of a first store over a 4-week window (28 days) provided by the forecast model. Column 602 indicates the day for each forecast. For example, on Day 1, 10 units of the first product was forecast to be sold at the first store. In a second example, on Day 11, 18 units of the first product was forecast to be sold at the first store. Such a forecast allows a user to plan for demand both in a short-term and long-term.

With reference to FIG. 2, without the intervening subroutine at 216 (that is, the block diagram 500 in FIG. 5), a user is provided with a 28-day forecast of demand, as shown in column 604. Following the example, where the second interval is 1 week, sales data is generated for Days 1-6. This sales data is added to the historical data (that was used to train the machine learning model), along with other signal data (such as weather, financial, seasonal, and so on) that formed part of the historical data. At day 7, the machine learning model is retrained, and a new forecast is provided, for Days 7-32. However, the real-time sales data on Days 1-6 is only used to forecast demand after Day 6. A user would like to use the daily sales data between Days 1-6, to adjust the demand during that period. The machine learning pipeline, however, is set to re-train every week, in this example. Below, is described how the real-time daily sales data can be incorporated to adjust the forecast provided by the machine learning model.

In this example, the average error, as discussed above, is-2%. In order to provide an adjusted forecast for Day 2-Day 28, this average error (based on sales data from Day 1) is subtracted from the forecast data (column 604) for each day, from Day 2-Day 28. For example, on Day 2, the original forecast (column 604) was 13 units. However, incorporation of sales data from all stores on Day 1, results in an adjusted forecast of 2% less the forecast of 13 units, which is (13−2%*13)−12.74 units. Similarly, for Day 11, the adjusted forecast (based on sales on Day 1) is now 18-2%*18)=17.64 units. The same correction applies to all of the other forecasts. Exemplary adjusted forecast data is shown in column 606 in table 600.

Following the above example, it is determined that the average error, based on sales data from Day 2, is about-6%. This sales data can be incorporated into the forecast data, to provide a second adjusted forecast, for sales for Day 3 to Day 28. At Day 3, the original forecast is 13 units. The second adjusted forecast is 13−6%*13=12.23 units. Similarly, at Day 11, the second adjusted forecast is 18−6%*18=16.93 units. The same correction applies to all of the other forecasts. Exemplary second adjusted forecast data is shown in column 608 in table 600.

The adjusted forecasts, as shown in columns 606 and 608 can be used by the user to adjust one or more supply chains to meet the adjusted demand forecasts. This can entail a change in the amount of good manufactured, the storing of the manufactured goods; and the transport of manufactured goods.

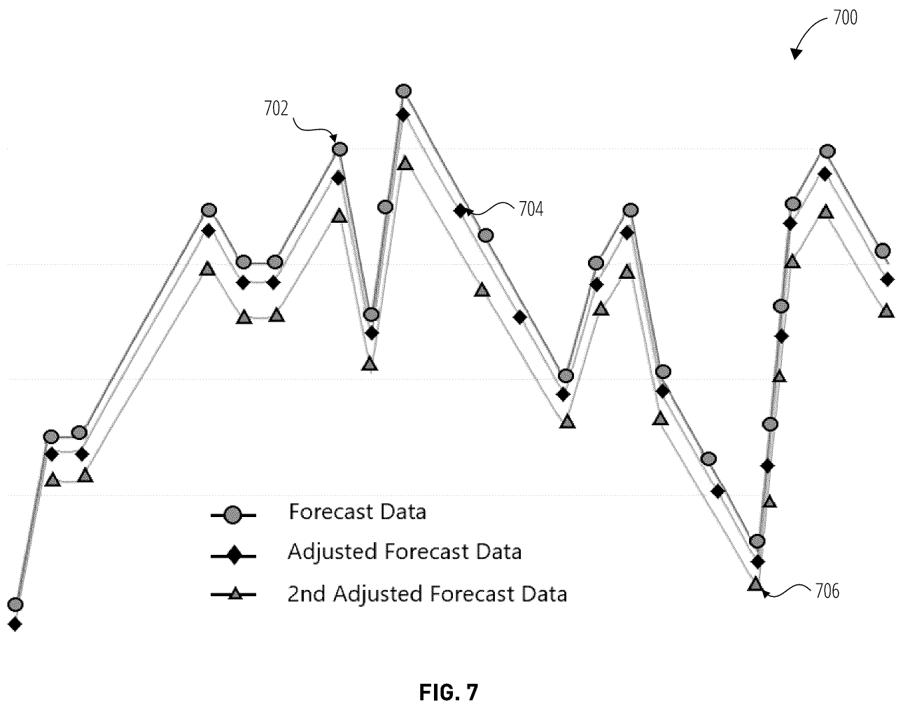

FIG. 7 illustrates a graphical representation of forecast data and adjusted forecast data in accordance with an embodiment, based on the data provided in FIG. 6.

Now referring to FIG. 7, shown is a graphical representation of forecast data 702 (column 604 in FIG. 6), first adjusted forecast data 704 (column 606 in FIG. 6), along with second adjusted forecast data 706 (column 608 in FIG. 6).

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computing apparatus comprising:
a processor; and
a memory storing instructions that, when executed by the processor, configure the apparatus to:
receive, by the processor, historical data comprising data compiled over a first time interval;
clean, by the processor, the historical data in preparation for feature generation;
generate, by the processor, a plurality of features based on the historical data;
train, by the processor, a machine-learning model using the plurality of features;
generate, by the processor, forecast data for a forecast window;
collect, by the processor, real-time data over a second time interval, the second time interval less than the forecast window;
determine, by the processor, an error in the forecast data, based on a difference between the forecast data and the real-time data; and
form, by the processor, an adjusted forecast data by removing the error from the forecast data.

2. The computing apparatus of claim 1, wherein the machine learn model is a deep-learning model, a statistical model, or a tree-based model.

3. The computing apparatus of claim 2, wherein when training the tree-based model, the instructions further configure the apparatus to:
join, by the processor, clean data obtained from a plurality of sources, into a single source; and
tune, by the processor, one or more hyperparameters; and
train, by the processor, the tree-based model based on the one or more tuned hyperparameters.

4. The computing apparatus of claim 1, wherein the historical data comprises historical sales data at a plurality of store locations, the real-time data comprises daily sales data at each store location of the plurality of store locations;
wherein when determining the error, the apparatus is configured to:
compare, by the processor, on a daily basis during the second time interval, the difference between the forecast data and the daily sales data at each store location; and
determine, by the processor, an average error across the plurality of store locations;
and wherein when forming the adjusted forecast data, the apparatus is configured to:
remove, by the processor, the average error from the forecast data at each store location.

5. The computing apparatus of claim 1, wherein the instructions further configure the apparatus to:
combine, by the processor, the real-time data with the historical data;
clean, by the processor, the historical data and the real-time data;
generate, by the processor, a second plurality of features based on the historical data and the real-time data;
re-train, by the processor, the machine-learning model using the second plurality of features;
generate, by the processor, a second set of forecast data for the forecast window;
collect, by the processor, a second set of real-time data over the second time interval;
determine, by the processor, a second error in the second set of forecast data, based on a second difference between the second set of forecast data and the second set of real-time data; and
form, by the processor, a second adjusted forecast data.

6. The computing apparatus of claim 1, wherein the historical data comprises sales data, and at least one of weather data, financial data and seasonal data.

7. A non-transitory computer-readable storage medium, the computer-readable storage medium including instructions that when executed by a computer, cause the computer to:
receive, by a processor, historical data comprising data compiled over a first time interval;
clean, by the processor, the historical data in preparation for feature generation;
generate, by the processor, a plurality of features based on the historical data;
train, by the processor, a machine-learning model using the plurality of features;
generate, by the processor, forecast data for a forecast window;
collect, by the processor, real-time data over a second time interval, the second time interval less than the forecast window;
determine, by the processor, an error in the forecast data, based on a difference between the forecast data and the real-time data; and
form, by the processor, an adjusted forecast data by removing the error from the forecast data.

8. The non-transitory computer-readable storage medium of claim 7, wherein the machine learn model is a deep-learning model, a statistical model, or a tree-based model.

9. The non-transitory computer-readable storage medium of claim 8, wherein when training the tree-based model, the instructions further configure the computer to:
join, by the processor, clean data obtained from a plurality of sources, into a single source; and
tune, by the processor, one or more hyperparameters; and
train, by the processor, the tree-based model based on the one or more tuned hyperparameters.

10. The non-transitory computer-readable storage medium of claim 7, wherein the historical data comprises historical sales data at a plurality of store locations, the real-time data comprises daily sales data at each store location of the plurality of store locations,
wherein when determining the error, the instructions further configure the computer to:
compare, by the processor, on a daily basis during the second time interval, the difference between the forecast data and the daily sales data at each store location; and
determine, by the processor, an average error across the plurality of store locations;
and wherein when forming the adjusted forecast data, the instructions further configure the computer to:
remove, by the processor, the average error from the forecast data at each store location.

11. The computer-readable storage medium of claim 7, wherein the instructions further configure the computer to:
combine, by the processor, the real-time data with the historical data;
clean, by the processor, the historical data and the real-time data;
generate, by the processor, a second plurality of features based on the historical data and the real-time data;
re-train, by the processor, the machine-learning model using the second plurality of features;
generate, by the processor, a second set of forecast data for the forecast window;
collect, by the processor, a second set of real-time data over the second time interval;
determine, by the processor, a second error in the second set of forecast data, based on a second difference between the second set of forecast data and the second set of real-time data; and
form, by the processor, a second adjusted forecast data.

12. The non-transitory computer-readable storage medium of claim 7, wherein the historical data comprises sales data, and at least one of weather data, financial data and seasonal data.

13. A computer-implemented method comprising:
receiving, by a processor, historical data comprising data compiled over a first time interval;
cleaning, by the processor, the historical data in preparation for feature generation;
generating, by the processor, a plurality of features based on the historical data;
training, by the processor, a machine-learning model using the plurality of features;
generating, by the processor, forecast data for a forecast window;
collecting, by the processor, real-time data over a second time interval, the second time interval less than the forecast window;
determining, by the processor, an error in the forecast data, based on a difference between the forecast data and the real-time data; and
forming, by the processor, an adjusted forecast data by removing the error from the forecast data.

14. The method of claim 13, wherein the machine learning model is a deep-learning model, a statistical model, or a tree-based model.

15. The method of claim 14, wherein training the tree-based model comprises:
joining, by the processor, clean data obtained from a plurality of sources, into a single source; and
tuning, by the processor, one or more hyperparameters; and
training, by the processor, the tree-based model based on the one or more tuned hyperparameters.

16. The method of claim 13 wherein the historical data comprises historical sales data at a plurality of store locations, the real-time data comprises daily sales data at each store location of the plurality of store locations,
wherein determining the error comprises:
comparing, by the processor, on a daily basis during the second time interval, the difference between the forecast data and the daily sales data at each store location; and
determining, by the processor, an average error across the plurality of store locations;
and wherein forming the adjusted forecast data comprises:
removing, by the processor, the average error from the forecast data at each store location.

17. The method of claim 13 further comprising:
combining, by the processor, the real-time data with the historical data;
cleaning, by the processor, the historical data and the real-time data;
generating, by the processor, a second plurality of features based on the historical data and the real-time data;
re-training, by the processor, the machine-learning model using the second plurality of features;
generating, by the processor, a second set of forecast data for the forecast window;
collecting, by the processor, a second set of real-time data over the second time interval;
determining, by the processor, a second error in the second set of forecast data, based on a second difference between the second set of forecast data and the second set of real-time data; and
forming, by the processor, a second adjusted forecast data.

18. The method of claim 13, wherein the historical data comprises sales data, and at least one of weather data, financial data and seasonal data.
